(19) United States
(12) Patent Application Publication
(10) Pub. No.: US 2015/0369140 A1
(43) Pub. Date: Dec. 24, 2015

(54) FIRING PATTERN MANAGEMENT FOR IMPROVED TRANSIENT VIBRATION IN VARIABLE CYLINDER DEACTIVATION MODE

(71) Applicant: GM Global Technology Operations LLC, Detroit, MI (US)

(72) Inventors: NITISH J. WAGH, NORTHVILLE, MI (US); RANDALL S. BEIKMANN, BRIGHTON, MI (US)

(21) Appl. No.: 14/310,063

(22) Filed: Jun. 20, 2014

(51) Int. Cl. F02D 17/02

(52) U.S. Cl. CPC F02D 17/02

(57) ABSTRACT

A system includes a cylinder control module that determines target numbers of cylinders of an engine to be activated during a period, determines, based on the target numbers and an engine speed, N predetermined sequences for controlling the cylinders of the engine during the period, determines whether a transition parameter is associated with at least one of the N predetermined subsequences and selectively adjusts at least one of the N predetermined subsequences based on the determination of whether a transition parameter is associated with at least two of the N predetermined sequences. The system further includes a cylinder actuator module that, during the period, controls the cylinders of the engine based on the N predetermined sequence and based on the at least one selectively adjusted predetermined sequences.

### FIELD

The present disclosure relates to internal combustion engines and more specifically to engine control systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. In some types of engines, air flow into the engine may be regulated via a throttle. The throttle may adjust throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

Under some circumstances, one or more cylinders of an engine may be deactivated. Deactivation of a cylinder may include deactivating opening and closing of intake valves of the cylinder and halting fueling of the cylinder. One or more cylinders may be deactivated, for example, to decrease fuel consumption when the engine can produce a requested amount of torque while the one or more cylinders are deactivated.

### SUMMARY

A system includes a cylinder control module that determines target numbers of cylinders of an engine to be activated during a period, determines, based on the target numbers and an engine speed, N predetermined sequences for controlling the cylinders of the engine during the period, determines whether a transition parameter is associated with at least one of the N predetermined subsequences and selectively adjusts at least one of the N predetermined subsequences based on the determination of whether a transition parameter is associated with at least two of the N predetermined subsequences. The system further includes a cylinder actuator module that, during the period, controls the cylinders of the engine based on the N predetermined subsequences and based on the at least one selectively adjusted predetermined subsequences.

In other features, cylinder control method includes: determining target numbers of cylinders of an engine to be activated during a period, determining, based on the target numbers and an engine speed, N predetermined subsequences for controlling cylinders of the engine during the period, determining whether a transition parameter is associated with at least one transition between two of the N predetermine subsequences, selectively adjusting at least one of the N predetermine sequences based on the determination a transition parameter is associated with at least two of the N predetermine sequences s, and controlling, during the period, the cylinders of the engine based on the N predetermined sequences.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the present disclosure;

FIG. 2 is a functional block diagram of an example engine control system according to the present disclosure;

FIG. 3 is a functional block diagram of an example cylinder control module according to the present disclosure; and

FIG. 4 is a flowchart depicting an example method of controlling cylinder activation and deactivation according to the present disclosure.

### DETAILED DESCRIPTION

Internal combustion engines combust an air and fuel mixture within cylinders to generate torque. Under some circumstances, an engine control module (ECM) may deactivate one or more cylinders of the engine. The ECM may deactivate one or more cylinders, for example, to decrease fuel consumption when the engine can produce a requested amount of torque while the one or more cylinders are deactivated. Deactivation of one or more cylinders, however, may increase powertrain-induced vibration relative to the activation of all of the cylinders.

The ECM of the present disclosure determines an average number of cylinders per sub-period to be activated during a future period including a plurality of sub-periods. Based on achieving the average number of cylinders over the future period, the ECM generates a first sequence indicating N target numbers of cylinders to be activated during the each of the plurality of sub-periods, respectively. N is an integer greater than or equal to 1. The ECM generates a second sequence indicating one or more predetermined subsequences for activating and deactivating cylinders to achieve the N target numbers of activated cylinders during each of the sub-periods, respectively. The predetermined subsequences are selected to smooth torque production and delivery, minimize harmonic vehicle vibration, minimize impulsive vibration characteristics, and minimize induction and exhaust noise.

The ECM generates a target sequence for activating and deactivating cylinders of the engine during the future period based on the predetermined subsequences. The cylinders are activated and deactivated based on the target sequence during the future period. More specifically, the cylinders are activated and deactivated based on the predetermined subsequences during each of the sub-periods, respectively. In some instances, the ECM may adjust one or more of the selected subsequences in order to reduce vibration during transition between one or more of the selected subsequences. Deactivation of a cylinder may include deactivating opening and closing of intake valves of the cylinder and halting fueling of the cylinder.

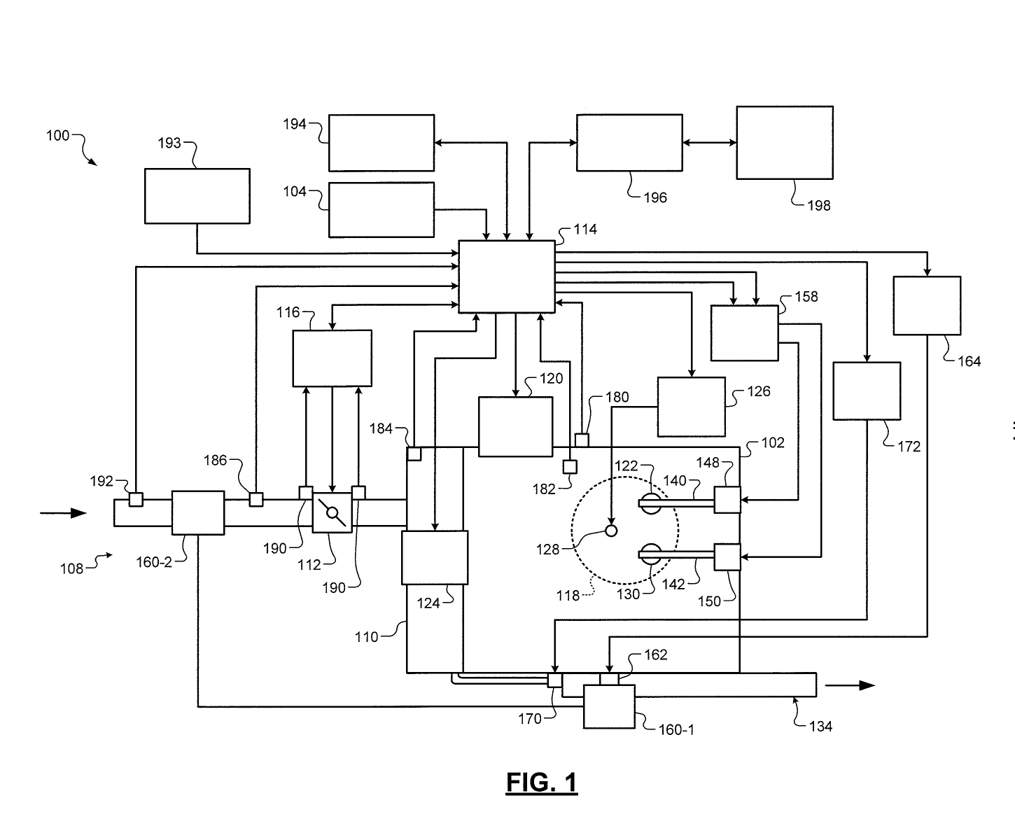

Referring now to FIG. 1, a functional block diagram of an example engine system 100 is presented. The engine system 100 of a vehicle includes an engine 102 that combusts an air/fuel mixture to produce torque based on driver input from a driver input module 104. Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, as discussed further below, which may improve fuel efficiency.

The engine 102 may operate using a four-stroke cycle. The four strokes, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes. For four-stroke engines, one engine cycle may correspond to two crankshaft revolutions.

When the cylinder 118 is activated, air from the intake manifold 110 is drawn into the cylinder 118 through an intake valve 122 during the intake stroke. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may halt provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time at which the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). While camshaft based valve actuation is shown and has been discussed, camless valve actuators may be implemented.

The cylinder actuator module 120 may deactivate the cylinder 118 by disabling opening of the intake valve 122 and/or the exhaust valve 130. The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158. In various other implementations, the intake valve 122 and/or the exhaust valve 130 may be controlled by actuators other than a camshaft, such as electromechanical actuators, electrohydraulic actuators, electromagnetic actuators, etc.

The engine system 100 may include a boost device that provides pressurized air to the intake manifold 110. For example, FIG. 1 shows a turbocharger including a turbine 160-1 that is driven by exhaust gases flowing through the exhaust system 134. The turbocharger also includes a compressor 160-2 that is driven by the turbine 160-1 and that compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. Although shown separated for purposes of illustration, the turbine 160-1 and the compressor 160-2 may be mechanically linked to each other, placing intake air in close proximity to hot exhaust. The compressed air charge may absorb heat from components of the exhaust system 134.

The engine system 100 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172.

Crankshaft position may be measured using a crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192. The engine system 100 may also include one or more other sensors 193. The ECM 114 may use signals from the sensors to make control decisions for the engine system 100.

The ECM 114 may communicate with a transmission control module 194 to coordinate shifting gears in a transmission (not shown). For example, the ECM 114 may reduce engine torque during a gear shift. The engine 102 outputs torque to a transmission (not shown) via the crankshaft. One or more coupling devices, such as a torque converter and/or one or more clutches, regulate torque transfer between a transmission input shaft and the crankshaft. Torque is transferred between the transmission input shaft and a transmission output shaft via the gears.

Torque is transferred between the transmission output shaft and wheels of the vehicle via one or more differentials, driveshafts, etc. Wheels that receive torque output by the transmission may be referred to as driven wheels. Wheels that do not receive torque from the transmission may be referred to as undriven wheels.

The ECM 114 may communicate with a hybrid control module 196 to coordinate operation of the engine 102 and an electric motor 198. The electric motor 198 may also function as a generator, and may be used to produce electrical energy for use by vehicle electrical systems and/or for storage in a battery. While only the electric motor 198 is shown and discussed, multiple electric motors may be implemented. In various implementations, various functions of the ECM 114, the transmission control module 194, and the hybrid control module 196 may be integrated into one or more modules.

Each system that varies an engine parameter may be referred to as an engine actuator. Each engine actuator has an associated actuator value. For example, the throttle actuator module 116 may be referred to as an engine actuator, and the throttle opening area may be referred to as the actuator value. In the example of FIG. 1, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the boost actuator module 164, and the EGR actuator module 172. For these engine actuators, the actuator values may correspond to a cylinder activation/deactivation sequence, fueling rate, intake and exhaust cam phaser angles, boost pressure, and EGR valve opening area, respectively. The ECM 114 may control the actuator values in order to cause the engine 102 to generate a desired engine output torque.

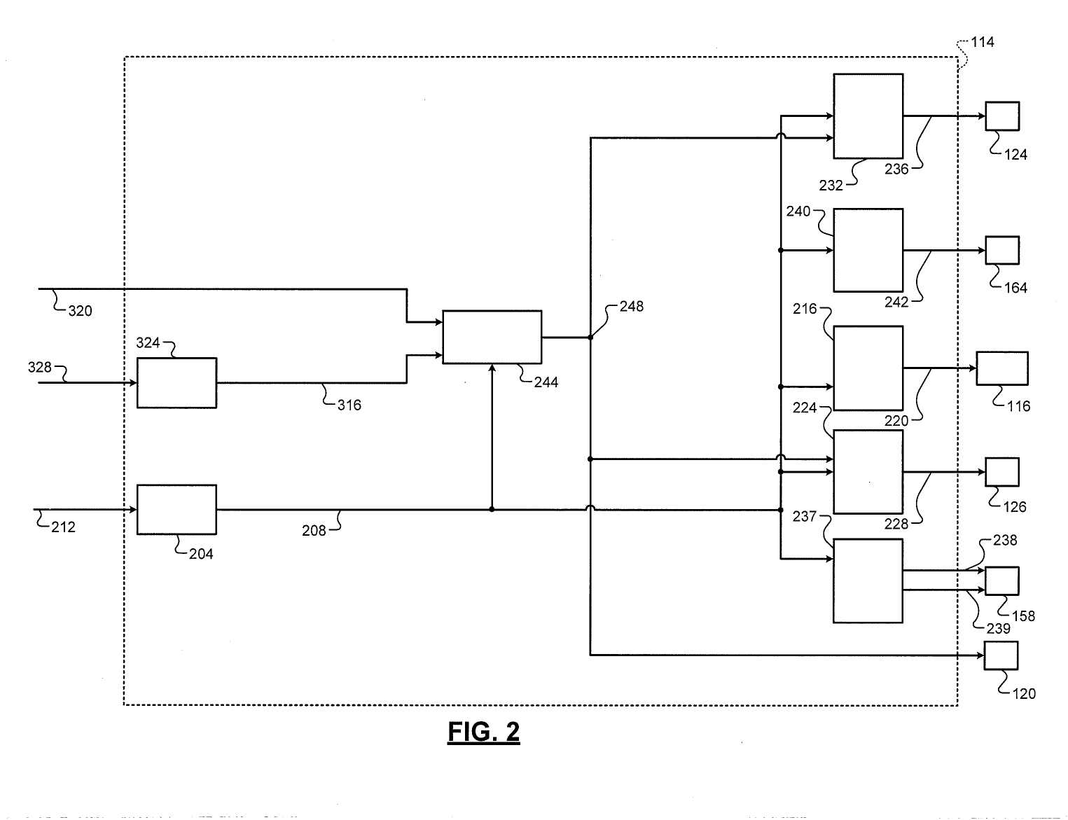

Referring now to FIG. 2, a functional block diagram of an example engine control system is presented. A torque request module 204 may determine a torque request 208 based on one or more driver inputs 212, such as an accelerator pedal position, a brake pedal position, a cruise control input, and/or one or more other suitable driver inputs. The torque request module 204 may determine the torque request 208 additionally or alternatively based on one or more other torque requests, such as torque requests generated by the ECM 114 and/or torque requests received from other modules of the vehicle, such as the transmission control module 194, the hybrid control module 196, a chassis control module, etc.

One or more engine actuators may be controlled based on the torque request 208 and/or one or more other parameters. For example, a throttle control module 216 may determine a target throttle opening 220 based on the torque request 208. The throttle actuator module 116 may adjust opening of the throttle valve 112 based on the target throttle opening 220.

A spark control module 224 may determine a target spark timing 228 based on the torque request 208. The spark actuator module 126 may generate spark based on the target spark timing 228. A fuel control module 232 may determine one or more target fueling parameters 236 based on the torque request 208. For example, the target fueling parameters 236 may include fuel injection amount, number of fuel injections for injecting the amount, and timing for each of the injections. The fuel actuator module 124 may inject fuel based on the target fueling parameters 236.

A phaser control module 237 may determine target intake and exhaust cam phaser angles 238 and 239 based on the torque request 208. The phaser actuator module 158 may regulate the intake and exhaust cam phasers 148 and 150 based on the target intake and exhaust cam phaser angles 238 and 239, respectively. A boost control module 240 may determine a target boost 242 based on the torque request 208. The boost actuator module 164 may control boost output by the boost device(s) based on the target boost 242.

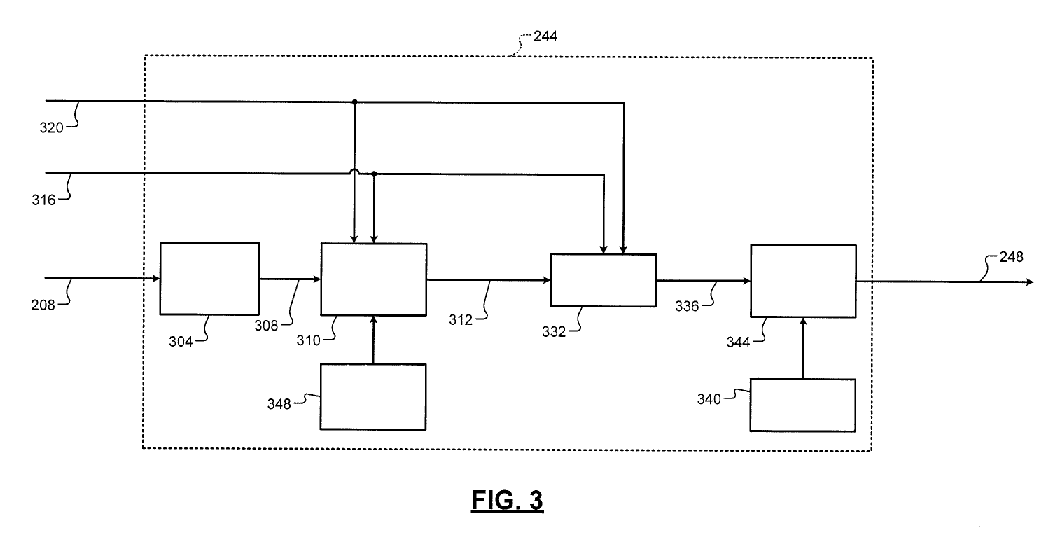

A cylinder control module 244 (see also FIG. 3) determines a target cylinder activation/deactivation sequence 248 based on the torque request 208. The cylinder actuator module 120 deactivates the intake and exhaust valves of the cylinders that are to be deactivated according to the target cylinder activation/deactivation sequence 248. The cylinder actuator module 120 allows opening and closing of the intake and exhaust valves of cylinders that are to be activated according to the target cylinder activation/deactivation sequence 248.

Fueling is halted (zero fueling) to cylinders that are to be deactivated according to the target cylinder activation/deactivation sequence 248, and fuel is provided the cylinders that are to be activated according to the target cylinder activation/deactivation sequence 248. Spark is provided to the cylinders that are to be activated according to the target cylinder activation/deactivation sequence 248. Spark may be provided or halted to cylinders that are to be deactivated according to the target cylinder activation/deactivation sequence 248. Cylinder deactivation is different than fuel cutoff (e.g., deceleration fuel cutoff) in that the intake and exhaust valves of cylinders to which fueling is halted during fuel cutoff are still opened and closed during the fuel cutoff whereas the intake and exhaust valves are maintained closed when deactivated.

Referring now to FIG. 3, a functional block diagram of an example implementation of the cylinder control module 244 is presented. A target cylinder count module 304 generates a target effective cylinder count (ECC) 308. The target ECC 308 corresponds to a target number of cylinders to be activated (i.e., fired) per engine cycle on average over the next P engine cycles (corresponding to the next M possible cylinder events in a predetermined firing order of the cylinders). Where P is an integer greater than or equal to two. One engine cycle may refer to the period for each of the cylinders of the engine 102 to accomplish one combustion cycle. For example, in a four-stroke engine, one engine cycle may correspond to two crankshaft revolutions.

The target ECC 308 may be an integer or a non-integer that is between zero and the total number of possible cylinder events per engine cycle, inclusive. Cylinder events include cylinder firing events and events where deactivated cylinders would, if activated, be fired. While the example where P is equal to 10 is discussed below, P is an integer greater than or equal to two. While engine cycles and the next P engine cycles will be discussed, another suitable period (e.g., the next N sets of X number of cylinder events) may be used.

The target cylinder count module 304 generates the target ECC 308 based on the torque request 208. The target cylinder count module 304 may determine the target ECC 308, for example, using a function or a mapping that relates the torque request 208 to the target ECC 308. For example only, for a torque request that is approximately 50% of a maximum torque output of the engine 102 under the operating conditions, the target ECC 308 may be a value corresponding to approximately half of the total number of cylinders of the engine 102. The target cylinder count module 304 may generate the target ECC 308 further based on one or more other parameters, such as one or more loads on the engine 102 and/or one or more other suitable parameters.

In some implementations, the target cylinder count module 304 determines whether the torque request 208 is within one of a plurality of predetermined torque request ranges. For example, a first torque request range includes a first lower torque value and a first upper torque value. The target cylinder count module 304 determines whether the torque request 208 is between the first lower torque value and the first upper torque value (i.e., greater than the first lower torque value and less than the first upper torque value). When the target cylinder count module 304 determines the torque request value is between the first lower torque value and the first upper torque value, the target cylinder count module 304 determines the target ECC 308 corresponding to the first torque request range.

It is understood that each of the plurality of torque request ranges may correspond to a target ECC. For example, the first torque request range corresponds to a first target ECC, while a second torque request range corresponds to a second target ECC. During a calibration phase of the vehicle, torque request ranges are identified corresponding to various operating parameters of the vehicle. Similarly, target ECCs corresponding to each torque request range are identified. The target cylinder count module 304 determines a torque request range that the torque request 208 falls within. The target cylinder count module 304 determines the target ECC that corresponds to the torque request range and sets the target ECC 308 equal to the target ECC corresponding to the torque request range. In this manner, the torque request 208 may vary within a range of values while the target ECC 308 remains steady.

A first sequence setting module 310 generates an activated cylinder sequence 312 to achieve the target ECC 308 over the next P engine cycles. The first sequence setting module 310 may determine the activated cylinder sequence 312, for example, using a mapping that relates the target ECC 308 to the activated cylinder sequence 312.

The activated cylinder sequence 312 includes a sequence of integers that correspond to the number of cylinders that should be activated during the next P engine cycles, respectively. In this manner, the activated cylinder sequence 312 indicates how many cylinders should be activated during each of the next P engine cycles. For example, the activated cylinder sequence 312 may include an array including P integers for the next P engine cycles, respectively, such as:
[I₁, I₂, I₃, I₄, I₅, I₆, I₇, I₈, I₉, I₁₀],
   where P is equal to 10, I₁ is an integer number of cylinders to be activated during the first one of the next 10 engine cycles, I₂ is an integer number of cylinders to be activated during the second one of the next N engine cycles, I₃ is an integer number of cylinders to be activated during the third one of the next N engine cycles, and so on.

When the target ECC 308 is an integer, that number of cylinders can be activated during each of the next P engine cycles to achieve the target ECC 308. For example only, if the target ECC 308 is equal to 4, 4 cylinders can be activated per engine cycle to achieve the target ECC 308 of 4. An example of the activated cylinder sequence 312 for activating 4 cylinders per engine cycle during the next P engine cycles is provided below where P is equal to 10.
[4, 4, 4, 4, 4, 4, 4, 4, 4, 4].

Different numbers of activated cylinders per engine cycle can also be used to achieve the target ECC 308 when the target ECC 308 is an integer. For example only, if the target ECC 308 is equal to 4, 4 cylinders can be activated during one engine cycle, 3 cylinders can be activated during another engine cycle, and 5 cylinders can be activated during another engine cycle to achieve the target ECC 308 of 4. An example of the activated cylinder sequence 312 for activating one or more different numbers of activated cylinders is provided below where P is equal to 10.
[4, 5, 3, 4, 3, 5, 3, 5, 4, 4].

When the target ECC 308 is a non-integer, different numbers of activated cylinders per engine cycle are used to achieve the target ECC 308. For example only, if the target ECC 308 is equal to 5.4, the following example activated cylinder sequence 312 can be used to achieve the target ECC 308:
[5, 6, 5, 6, 5, 6, 5, 5, 6, 5]
   where P is equal to 10, 5 indicates that 5 cylinders are activated during the corresponding ones of the next 10 engine cycles, and 6 indicates that 6 cylinders are activated during the corresponding ones of the next 10 engine cycles. While use of the two nearest integers to a non-integer value of the target ECC 308 have been discussed as examples, other integers may be used additionally or alternatively.

The first sequence setting module 310 may update or select the activated cylinder sequence 312 based on one or more other parameters, such as engine speed 316 and/or a throttle opening 320. For example only, the first sequence setting module 310 may update or select the activated cylinder sequence 312 such that greater numbers of activated cylinders are used near the end of the next P engine cycles (and lesser numbers of activated cylinders are used near the beginning of the next P engine cycles) when the engine speed 316 and/or the throttle opening 320 is increasing. This may provide for a smoother transition to an increase in the target ECC 308. The opposite may be true when the engine speed 316 and/or the throttle opening 320 is decreasing.

An engine speed module 324 (FIG. 2) may generate the engine speed 316 based on a crankshaft position 328 measured using the crankshaft position sensor 180. The throttle opening 320 may be generated based on measurements from one or more of the throttle position sensors 190.

A subsequence setting module 332 sets a sequence of subsequences 336 based on the activated cylinder sequence 312 and the engine speed 316. The sequence of subsequences 336 includes N indicators of N predetermined cylinder activation/deactivation subsequences to be used to achieve the corresponding numbers of activated cylinders (indicated by the activated cylinder sequence 312) during the next P engine cycles, respectively. The subsequence setting module 332 may set the sequence of subsequences 336, for example, using a mapping that relates the engine speed 316 and the activated cylinder sequence 312 to the sequence of subsequences 336.

Statistically speaking, one or more possible cylinder activation/deactivation subsequences are associated with each possible number of activated cylinders per engine cycle. A unique indicator may be associated with each of the possible cylinder activation/deactivation subsequences for achieving a given number of activated cylinders. The following tables include example indicators and possible subsequences for 5 and 6 active cylinders per engine cycle with 8 cylinder events per engine cycle:

| 5 Cylinders Firing | | 6 Cylinders Firing | |
|---|---|---|---|
| Unique indicator | Subsequence | Unique indicator | Subsequence |
| 5_01 | 00011111 | 6_01 | 00111111 |
| 5_02 | 00101111 | 6_02 | 01011111 |
| . | . | . | . |
| . | . | . | . |
| . | . | . | . |
| 5_10 | 01011101 | 6_10 | 10110111 |
| 5_11 | 01011110 | 6_11 | 10111011 |
| . | . | . | . |
| . | . | . | . |
| . | . | . | . |
| 5_28 | 10101011 | 6_28 | 11111100 |
| . | . | | |
| . | . | | |
| . | . | | |
| 5_56 | 11111000 | | |

where a 1 in a subsequence indicates that the corresponding cylinder in the firing order should be activated and a 0 indicates that the corresponding cylinder should be deactivated. While only possible subsequences for 5 and 6 active cylinders per engine cycle are provided above, one or more possible cylinder activation/deactivation subsequences are also associated with each other number of active cylinders per engine cycle.

In another implementation, subsequences having different lengths and/or subsequences with lengths that are different than the number of cylinder events per engine cycle can be used. In order to maintain a pressure within the intake manifold 110, a subsequence may transition from activating another predetermined number of cylinders in a first number of cylinder events to activating a predetermined number of cylinders in a second number of cylinder events. For example, the subsequence may transition from activating 3 cylinders out of a potential of 8 cylinder events to activating 3 cylinders out of a potential of 7 cylinder events. The following tables include example indicators and possible subsequences for 3 active cylinders out of a potential of 8 cylinder events per engine cycle and 3 active cylinders out of a potential of 7 cylinder events per subsequence:

| 3 Cylinders Firing 8 Potential | | 3 Cylinders Firing 7 Potential | |
|---|---|---|---|
| Unique indicator | Subsequence | Unique indicator | Subsequence |
| 3_8_01 | 00100101 | 3_7_01 | 0010101 |
| 3_8_02 | 00100110 | 3_7_02 | 0010110 |
| . | . | . | . |
| . | . | . | . |
| . | . | . | . |
| 3_8_10 | 01100010 | 3_7_10 | 0011001 |
| 3_8_11 | 01101000 | 3_7_11 | 0100101 |
| . | . | . | . |
| . | . | . | . |
| . | . | . | . |
| 3_8_28 | 10101000 | 3_7_28 | 1000101 |
| . | . | | |
| . | . | | |
| . | . | | |
| 3_8_56 | 11100000 | | |

While only possible subsequences for 3 out of 8 active cylinders and 3 out of 7 active cylinders per engine cycle are provided above, one or more possible cylinder activation/deactivation subsequences are also associated with each other number of active cylinders during each of the M cylinder events per engine cycle.

During a calibration phase of vehicle design, possible subsequences and sequences of the possible sequences producing minimum levels of vibration, minimum induction and exhaust noise, desired vibration characteristics, more even torque production/delivery, and better linkability with other possible subsequences are identified for various engine speeds. The identified subsequences are stored as predetermined cylinder activation/deactivation subsequences in a subsequence database 340.

Further, transition parameters between the subsequences may be identified and stored in the subsequence database 340. The transition parameters may indicate whether to truncate an outgoing subsequence and and/or to delay the start of an incoming subsequence. It is understood the outgoing subsequence may be repeated a plurality of times prior to transitioning to the incoming subsequence. The transition patterns may include a first value and a second value. The first value indicates whether to truncate an outgoing subsequence. For example, when the first value is greater than 0, the outgoing subsequence is truncated by the value of the first value. The second value indicates whether to delay the start of an incoming subsequence. For example, when the second value is greater than 0, the incoming subsequence is delayed by the value of the second value. By way of non-limiting example, a first transition pattern may be [2,5]. The outgoing subsequence is truncated by 2. In other words, the last 2 values of the outgoing subsequence are removed. The incoming subsequence is delayed by 5. In other words, the first 5 values of the incoming subsequence are removed. The outgoing subsequence and the incoming subsequence are then combined into an adjusted subsequence.

The transition parameters may be based on a length of the outgoing subsequence, a length of the incoming subsequence, an engine speed, a selected transmission gear, engine torque level, and other vehicle characteristics and operating conditions. During transition between an outgoing subsequence and an incoming subsequence, a driver and/or passenger within the vehicle may feel a vibration and/or a bump. This may be caused by a transition between subsequences of different lengths. The transition parameters truncate and/or delay the subsequences in order to reduce or remove the vibration and/or bump as felt by the driver and/or passenger.

For example, a first engine speed, a first subsequence may be selected in order to achieve a first cylinder firing pattern. As the engine speed changes, a second subsequence may be selected to achieve a second cylinder firing pattern. It is understood the first subsequence may be repeated a plurality of times prior to transitioning to the second subsequence. Transition parameters are identified that may effectively reduce or remove the vibration as a result of a transition between subsequences. In some instances, the first and second subsequence may be different sequence length. For example, the first subsequence may be a 3 out of 8 pattern. In other words, 3 cylinders are active out of 8 possible firing events. The second subsequence may be a 3 out of 7 pattern. In other words, 3 cylinders are active out of 7 possible firing events.

A transition pattern of [2,5] may effectively reduce or remove the vibration and/or bump as felt by the driver and/or passenger. Applying the transition pattern would truncate the 3 out of 8 firing pattern by 2 possible firing events and delay the start of the 3 out of 7 firing pattern by 5 possible firing events. The resulting adjusted sequence would include 8 possible firing events.

During the calibration phase of the vehicle design, all possible transitions between all identified possible subsequences are identified. Transition parameters associated with each possible transition may be identified and stored in the subsequence database 340.

During vehicle operation, the subsequence setting module 332 sets the sequence of subsequences 336 based on the activated cylinder sequence 312 and the engine speed 316. An example of the sequence of subsequences 336 for the example activated cylinder sequence of [5, 6, 5, 6, 5, 6, 5, 5, 6, 5] is:
[5_{—}23, 6_{—}25, 5_{—}19, 6_{—}22, 5_{—}55, 6_{—}01, 5_{—}23, 5_{—}21, 6_{—}11, 5_{—}29],
   where 5_{—}23 is the indicator of one of the predetermined cylinder activation/deactivation subsequences that is to be used to activate 5 cylinders during the first one of the next P engine cycles, where 6_{—}25 is the indicator of one of the predetermined cylinder activation/deactivation subsequences that is to be used to activate 6 cylinders during the second one of the next P engine cycles, 5_{—}19 is the indicator of one of the predetermined cylinder activation/deactivation subsequences that is to be used to activate 5 cylinders during the third one of the next P engine cycles, 6_{—}22 is the indicator of one of the predetermined cylinder activation/deactivation subsequences that is to be used to activate 6 cylinders during the fourth one of the next P engine cycles, and so on.

In another implementation, the subsequence setting module 332 determines whether to adjust one or more predetermined cylinder activation/deactivation subsequences. For example, the subsequence 336 may include a subsequence pair comprising a first subsequence and second subsequence. The first and second subsequences may be of different subsequence lengths. Transitioning between subsequences of different lengths may be felt as a vibration and/or a bump to a driver or a passenger of the vehicle. In order to produce an acceptable transient vibration, the subsequence setting module 332 may selectively adjust one or more predetermined cylinder activation/deactivation subsequences.

For example, the subsequence setting module 332 sets the sequence of subsequences 336 based on the activated cylinder sequence 312 and the engine speed 316. The second subsequence immediately follows the first subsequence. However, it is noted that while the identifiers first and second are used, the subsequence pair may occur anywhere within the subsequence 336. Further, the first subsequence may be repeated multiple times prior to transitioning to the second subsequence. By repeating a subsequence the vehicle experiences less transient vibration. Further, an average target ECC per engine cycle may be when the target ECC 304 is a non-integer value. For example, as described above, the target ECC is the average number of cylinder firings per engine cycle.

A subsequence may have a subsequence length X. A sequence may repeat the subsequence Y times and include Z potential firing events, where Z=X*Y. By way of non-limiting example only, a subsequence may fire 4 cylinders out of every 7 potential firing events, the sequence repeats the subsequence 8 times, resulting in 56 potential firing events during the sequence. During the sequence, 32 cylinder firings occur of the potential 56 (i.e., 4 of every 7, or 4*8 out of 7*8). The ECC is equal to the number of cylinders that fire per engine cycle, on average, during the sequence. In the example, assuming the vehicle includes 8 cylinders, 56 firing events occurs every 7 engine cycles (i.e., Z divided by the number of cylinders). The ECC would be equal to 32 cylinder firings divided by 7 engine cycles, or 4.57 effective cylinders fired every engine cycle.

The subsequence setting module 332 may determine a transition parameter associated with a transition between the first and second subsequences. As described above, the transition parameter is stored in subsequence database 340. The subsequence setting module 332 determines a transition parameter associated with the transition between the first and second subsequences. The subsequence setting module 332 selectively adjusts the first and second subsequence based on the transition parameter.

As described above, a subsequence may transition from activating a predetermined number of cylinders in a first number of cylinder events to activating another predetermined number of cylinders in a second number of cylinder events. For example, the subsequence may transition from activating 3 cylinders out of a potential of 8 cylinder events to activating 3 cylinders out of 7 cylinder events.

The subsequence setting module 332 sets the sequence of subsequences 336 based on the activated cylinder sequence 312 and the engine speed 316. An example of the sequence of subsequences 336 for an example activated cylinder sequence is:
[3_{—}8_{—}01, 3_{—}8_{—}01, 3_{—}8_{—}01, 3_{—}8_{—}01, 3_{—}7_{—}01, 3_{—}7_{—}01, 37_{—}01, 3_{—}7_{—}01, 37_{—}01, 3_{—}7_{—}01],
   where 3_{—}8_{—}01 is the indicator of one of the predetermined cylinder activation/deactivation subsequences that is to be used to activate 3 cylinders during 8 potential cylinder events during a first sequence of the next P engine cycles and where 3_{—}7_{—}01 is the indicator of one of the predetermined cylinder activation/deactivation subsequences that is to be used to activate 3 cylinders during 7 potential cylinder events during a second sequence of the next P engine cycles.

In the example above, the subsequence 336 includes a sequence pair that includes a first subsequence (3_{—}8_{—}01) and a second subsequence (3_{—}7_{—}01) that are of different subsequence lengths. For example, 3_{—}8_{—}01 has a subsequence of 00100101 (i.e., a length of 8) and 3_{—}7_{—}01 has a subsequence of 0010101 (i.e., a length of 7). The transition between these subsequences would be to join them as 00100101:0010101. This transition may be felt as a vibration and/or a bump to the driver and/or a passenger of the vehicle. The subsequence setting module 332 selectively adjusts one or both of the subsequences based on the transition parameter associated to a transition between the 3_{—}8_{—}01 subsequence and the 3_{—}7_{—}01 subsequence.

In the example above, the transition parameter for the transition between the 3_{—}8_{—}01 subsequence and the 3_{—}7_{—}01 subsequence may be [2,3]. The transition parameter is a predetermined parameter. During calibration of the vehicle, transition parameters are identified for each possible transition between each possible subsequence pairs. In other words, each possible outgoing subsequence includes a transition into each possible incoming subsequence. A transition parameter that reduces and/or removes the vibration during the transition, for the given operating conditions, is identified and stored in the database 340.

The subsequence setting module 332 selectively adjusts the 3_{—}8_{—}01 subsequence and the 3_{—}7_{—}01 subsequence based on the [2,3] transition parameter. For example, the subsequence setting module 332 adjusts the 3_{—}8_{—}01 subsequence from 00100101 to 001001 (i.e., eliminating the last two events) and adjusts the 3_{—}7_{—}01 subsequence from 0010101 to 0101 (i.e., eliminating the first three events).

The resulting transition would be an adjusted subsequence of 001001:0101. The adjusted subsequence may provide less transient vibration than the original transition between the 3_{—}8_{—}01 subsequence and the 3_{—}7_{—}01 subsequence. Further, the resulting subsequence activates 4 cylinders out of 10 cylinder events (i.e., 40%). Whereas the 3_{—}8_{—}01 subsequence activates 3 cylinders out of 8 cylinder events (i.e., 37.5%) and the 3_{—}7_{—}01 subsequence activates 3 cylinders out of 7 cylinder events (i.e., 42.9%). By applying the transition parameter, the resulting transition produces an output torque between the 3_{—}8_{—}01 subsequence and the 3_{—}7_{—}01 subsequence, resulting in a more gradual increase in output torque. The subsequence setting module 332 replaces the first subsequence (3_{—}8_{—}01) and the second subsequence (3_{—}7_{—}01) with the adjusted subsequence within the sequence of subsequences 336. In this manner, the subsequence setting module 332 identifies transitions that may result in a vibration and/or bump and selective applies a transition parameter in order to reduce or remove the vibration and/or bump from the sequence of subsequences 336.

A second sequence setting module 344 receives the sequence of subsequences 336 and generates the target cylinder activation/deactivation sequence 248. More specifically, the second sequence setting module 344 sets the target cylinder activation/deactivation sequence 248 to the predetermined cylinder activation/deactivation subsequences indicated in the sequence of subsequences 336, in the order specified in the sequence of subsequences 336. The second sequence setting module 344 retrieves the predetermined cylinder activation/deactivation subsequences indicated from the subsequence database 340 and the adjusted subsequence. It is understood that the sequence of subsequences 336 may include one or more adjusted subsequences. Further, the sequence of subsequences 336 may not include any adjusted subsequences. The cylinders are activated according to the target cylinder activation/deactivation sequence 248 during the next N engine cycles.

It may be desirable to vary the activated cylinder sequence 312 from one set of P engine cycles to another set of P engine cycles. This variation may be performed, for example, to prevent harmonic vibration from being experienced within a passenger cabin of the vehicle or to maintain a random vibration characteristic. For example, two or more predetermined activated cylinder sequences may be stored in an activated cylinder sequence database 348 for a given target ECC, and predetermined percentages of use may be provided for each of the predetermined activated cylinder sequences. If the target ECC 308 remains approximately constant, the first sequence setting module 310 may select the predetermined activated cylinder sequences for use as the activated cylinder sequence 312 in an order based on the predetermined percentages.

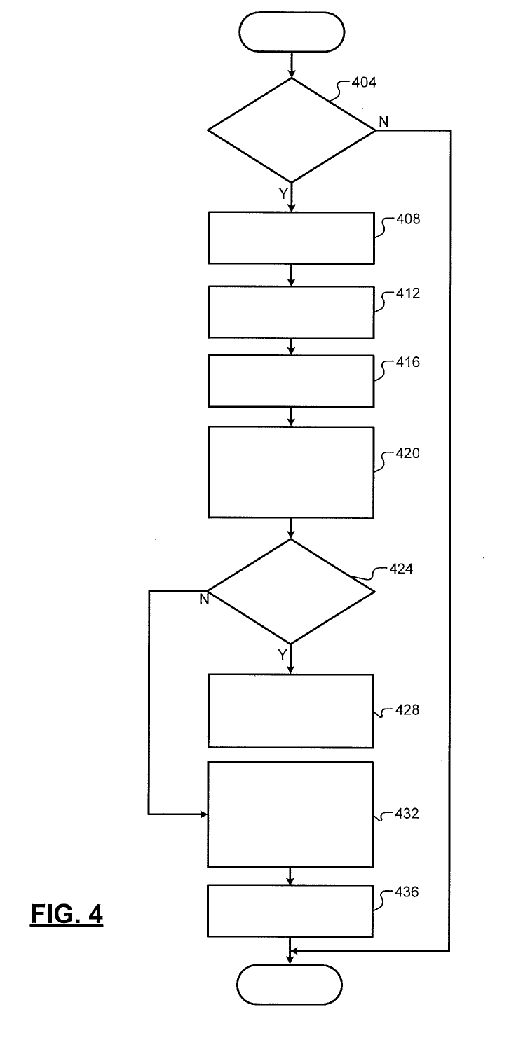

Referring now to FIG. 4, a flowchart depicting an example method of controlling cylinder activation and deactivation is presented. At 404, the cylinder control module 244 determines whether one or more enabling conditions are satisfied. For example, the cylinder control module 244 determines whether a steady-state or quasi steady-state operating condition is occurring at 404. If true, control continues at 408. If false, control ends. A steady-state or a quasi steady-state operating condition may be said to be occurring, for example, when the engine speed 316 has changed by less than a predetermined amount (e.g., approximately 100-200 RPM) over a predetermined period (e.g., approximately 5 seconds). Additionally or alternatively, the throttle opening 320 and/or one or more other suitable parameters may be used to determine whether a steady-state or a quasi steady-state operating condition is occurring.

At 408, the target cylinder count module 304 generates the target ECC 308. The target cylinder count module 304 determines the target ECC 308 based on the torque request 208 and/or one or more other parameters, as discussed above. The target ECC 308 corresponds to a target number of cylinders to be activated per engine cycle on average over the next P engine cycles.

The first sequence setting module 310 generates the activated cylinder sequence 312 at 412. The first sequence setting module 310 determines the activated cylinder sequence 312 based on the target ECC 308 and/or one or more other parameters, as discussed above. The activated cylinder sequence 312 includes a sequence of N integers that correspond to the number of cylinders that should be activated during the next P engine cycles, respectively.

The subsequence setting module 332 generates the sequence of subsequences 336 at 416. The subsequence setting module 332 determines the sequence of subsequences 336 based on the activated cylinder sequence 312, the engine speed 316, and/or one or more other parameters, as discussed above. The sequence of subsequences 336 includes N indicators of N predetermined cylinder activation/deactivation subsequences to be used to achieve the corresponding numbers of activated cylinders indicated by the activated cylinder sequence 312.

At 420, the second sequence setting module 344 retrieves the predetermined cylinder activation/deactivation subsequences indicated by the sequence of subsequences 336. The second sequence setting module 344 retrieves the predetermined cylinder activation/deactivation subsequences from the subsequence database 340. Each of the predetermined cylinder activation/deactivation subsequences includes a sequence for activating and deactivating cylinders during one of the next P engine cycles.

At 424, the subsequence setting module 332 identifies transitions between each of the retrieved, predetermined cylinder activation/deactivation subsequences. The subsequence setting module 332 determines whether to apply a transition parameter based on a determination of whether a transition has an associated transition parameter. For example, a transition may be associated with an outgoing subsequence and an incoming subsequence. The outgoing subsequence and the incoming subsequence may be of different sequence lengths. The transition between the outgoing subsequence and incoming subsequence (of different lengths) may result in a vibration and/or bump as felt by a driver or passenger within the vehicle. A transition parameter may be associated with the transition.

The transition parameter reduces and/or removes the vibration and/or bump. Further, the outgoing subsequence and the incoming subsequence may be of the same sequence length. The transition between the outgoing and incoming subsequence may include an associated transition parameter. In other words, transitioning sequences of different lengths as well as transition sequences of the same length may result in a vibration and/or bump (i.e., depending on the particular subsequences being transitioned).

If true, control continues at 428. If false, control continues at 432. At 428, the subsequence setting module 332 selectively applies a transition parameter to at least one of the outgoing subsequence and the incoming subsequence based on the transition parameter. The subsequence setting module 332 communicates the adjusted subsequences to the second sequence setting module 344. Additionally or alternatively, the subsequence setting module 332 removes the outgoing subsequence and/or the incoming subsequence. The subsequence setting module 332 includes the at least one adjusted subsequence within the sequence of subsequences 336.

At 432, the second sequence setting module 344 generates the target cylinder activation/deactivation sequence 248 based on the retrieved, predetermined cylinder activation/deactivation subsequences. Further, the second sequence setting module 344 may determine whether the sequence setting module 332 adjusted one or more subsequences. When the second sequence setting module 334 determines the sequencer setting module 332 adjusted at least one subsequence, the second sequence setting module 344 includes the at least one adjusted subsequence in the target cylinder activation/deactivation sequence 248.

More specifically, the second sequence setting module 344 assembles the retrieved, predetermined cylinder activation/deactivation sequences, in the order indicated by the sequence of subsequences 336, to generate the target cylinder activation/deactivation sequence 248. In this manner, the target cylinder activation/deactivation sequence 248 includes a sequence for activating and deactivating cylinders during the next N engine cycles.

The engine 102 is controlled based on the target cylinder activation/deactivation sequence 248 at 436. For example, if the target cylinder activation/deactivation sequence 248 indicates that the next cylinder in the firing order should be activated, the following cylinder in the firing order should be deactivated, and the following cylinder in the firing order should be activated, then the next cylinder in the predetermined firing order is activated, the following cylinder in the predetermined firing order is deactivated, and the following cylinder in the predetermined firing order is activated.

The cylinder control module 244 deactivates opening of the intake and exhaust valves of cylinders that are to be deactivated. The cylinder control module 244 allows opening and closing of the intake and exhaust valves of cylinders that are to be activated. The fuel control module 232 provides fuel to cylinders that are to be activated and halts fueling to cylinders that are to be deactivated. The spark control module 224 provides spark to cylinders that are to be activated. The spark control module 224 halts spark or provides spark to cylinders that are to be deactivated. While control is shown as ending, FIG. 4 is illustrative of one control loop, and a control loop may be executed, for example, every predetermined amount of crankshaft rotation.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); a discrete circuit; an integrated circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be partially or fully implemented by one or more computer programs executed by one or more processors. The computer programs include processor-executable instructions that are stored on at least one non-transitory tangible computer readable medium. The computer programs may also include and/or rely on stored data. Non-limiting examples of the non-transitory tangible computer readable medium include nonvolatile memory, volatile memory, magnetic storage, and optical storage.

What is claimed is:

1. A cylinder control system of a vehicle, comprising:
a cylinder control module that:
determines target numbers of cylinders of an engine to be activated during a period;
determines, based on the target numbers and an engine speed, N predetermined subsequences for controlling the cylinders of the engine during the period;
determines whether a transition parameter is associated with at least one transition between two of the N predetermined subsequences;
selectively adjusts at least one of the N predetermined subsequences based on the determination of whether a transition parameter is associated with at least two of the N predetermined subsequences; and
a cylinder actuator module that, during the period, controls the cylinders of the engine based on the N predetermined subsequences and the at least one selectively adjusted predetermine subsequences.

2. The cylinder control system of claim 1 wherein the cylinder control module determines the target numbers of cylinders to be activated during the period based on an engine torque request.

3. The cylinder control system of claim 1 wherein the cylinder control module generates a target sequence for activating and deactivating cylinders of the engine based on the N predetermined subsequences and the at least one adjusted predetermined subsequences.

4. The cylinder control system of claim 3 wherein the cylinder actuator module activates opening of intake and exhaust valves of first ones of the cylinders that are to be activated based on the target sequence and the at least one adjusted predetermine subsequence and deactivates opening intake and exhaust valves of second ones of the cylinders that are to be deactivated based on the target sequence and the at least one adjusted predetermined subsequence.

5. The cylinder control system of claim 1 wherein the cylinder control module determines whether a transition parameter is associated with at least two of the N predetermined subsequences.

6. The cylinder control system of claim 5 wherein the cylinder control module retrieves the transition parameter associated with a transition between the at least two of the N predetermined subsequences.

7. The cylinder control system of claim 6 wherein the cylinder control module selectively adjusts at least one of the at least two of the N predetermined subsequences based on the transition parameter.

8. The cylinder control system of claim 7 wherein the transition parameter includes a first value and a second value.

9. The cylinder control system of claim 1 wherein the cylinder control module truncates at least one of the at least two predetermined subsequences based on a determination that the first value of the transition parameter is greater than 0 and wherein the cylinder control module delays a start of the other at least two predetermine subsequences based on at determination that the second value is greater than 0.

10. The cylinder control system of claim 9 wherein the cylinder control module truncates at least one of the at least two predetermined subsequences based on the first value of the transition parameter and wherein the cylinder control module delays a start of the other of the at least two predetermine subsequences based on the second value of the transition parameter.

11. A cylinder control method of a vehicle, comprising:
determining target numbers of cylinders of an engine to be activated during a period,
determining, based on the target numbers and an engine speed, N predetermined subsequences for controlling cylinders of the engine during the period;
determining whether a transition parameter is associated with at least one transition between two of the N predetermine subsequences;
selectively adjusting at least one of the N predetermine subsequences based on the determination of whether a transition parameter is associated with at least two of the N predetermine subsequences; and
controlling, during the period, the cylinders of the engine based on the N predetermined subsequences and the at least one selectively adjusted predetermine subsequences.

12. The cylinder control method of claim 11 further comprising, determining the target numbers of cylinders to be activated during the period based on an engine torque request.

13. The cylinder control method of claim 11 further comprising generating a target sequence for activating and deactivating cylinders of the engine based on the N predetermined subsequences and the at least one adjusted predetermined subsequences.

14. The cylinder control method of claim 13 further comprising activating opening of intake and exhaust valves of first ones of the cylinders that are to be activated based on the target sequence and the one adjusted predetermined subsequences and deactivating opening of intake and exhaust valves of second ones of the cylinders that are to be deactivated based on the target sequence and the at least one adjusted predetermined subsequence.

15. The cylinder control method of claim 11 further comprising determining whether a transition parameter is associated with at least two of the N predetermined sequences.

16. The cylinder control method of claim 15 further comprising retrieving the transition parameter associated with a transition between the at least two of the N predetermined subsequences.

17. The cylinder control method of claim 16 further comprising selectively adjusting at least one of the at least two of the N predetermined subsequences based on the transition parameter.

18. The cylinder control method of claim 17 wherein the transition parameter includes a first value and a second value.

19. The cylinder control method of claim 11 further comprising truncating at least one of the at least two predetermined subsequences based on the first value and delaying a start of the other of the at least two predetermined subsequences based on the second value.

20. The cylinder control method of claim 19 further comprising generating an adjust subsequence based on the truncated at least one of the at least two predetermined subsequences and the delayed other of the at least two predetermined subsequence.
